(19) United States
(12) Patent Application Publication
(10) Pub. No.: US 2014/0172634 A1
(43) Pub. Date: Jun. 19, 2014

(54) DATA MANAGEMENT IN A GLOBAL SHOPPING CART

(71) Applicant: MASTERCARD INTERNATIONAL INCORPORATED, Purchase, NY (US)

(72) Inventors: Jennifer Dogin, Mamaroneck, NY (US); Brian Maw, Norwalk, CT (US)

(21) Appl. No.: 13/829,533

(22) Filed: Mar. 14, 2013

Related U.S. Application Data
(60) Provisional application No. 61/737,556, filed on Dec. 14, 2012.
(60) Provisional application No. 61/750,905, filed on Jan. 10, 2013.
(60) Provisional application No. 61/763,755, filed on Feb. 12, 2013.

(51) Int. Cl. G06Q 30/06

(52) U.S. Cl. CPC G06Q 30/0633
USPC 705/26.8

(57) ABSTRACT

A data management system for use in a global shopping cart and a method for its use are provided. The global shopping cart includes a storage medium having thereon computer instructions for implementing one or more functions of the global shopping cart, and a processor for executing the computer instructions to provide functions including management of data relationships between the global shopping cart and data management access components. The global shopping cart has a flexible application programming interface (API) framework sufficient to support the management of data relationships between the global shopping cart and data access components.

### RELATED APPLICATIONS

This application claims priority in U.S. provisional application Ser. No. 61/737,556 filed on Dec. 14, 2012, U.S. provisional application Ser. No. 61/750,905 filed on Jan. 10, 2013, and U.S. provisional application Ser. No. 61/763,755 filed on Feb. 12, 2013. All three of these U.S. provisional applications are incorporated herein by reference in their entirety.

### BACKGROUND OF THE DISCLOSURE

1. Field of the Disclosure

The present disclosure relates to data management in a global shopping cart. More particularly, the present disclosure relates to management of data relationships between a global online shopping cart and various manager components that encompass data management access.

2. Description of the Related Art

The multitude of shopping choices available on-line and at points of sale have made maintaining the track of purchases a relatively complex task. It is sometimes very difficult to track and organize all data concerning purchases made by an individual or a family over a period of time. Further, there are projects undertaken that may extend for a year or more. For example, planning a wedding or a construction project, such as adding one or more rooms to a house, may take over a year. There are other tasks, such as office supply inventory control, where the task is repetitive in nature, as opposed to a task with a definitive end.

During the course of these projects, it is desirable to have an organized way to construct a list of items that must be purchased or services that must be obtained, and to keep track of what has been purchased, and what needs to be purchased. Often, after a project has been completed, it is desirable to have information on the project so that, if necessary, replacement items can be purchased, warrantees can be exercised, and additional services of the type utilized can be obtained. Generally, during the course of several years, the information required to purchase replacement components, exercise warrantees, or find the required services may no longer be available due to the loss of paper records and receipts.

For some projects, such as a wedding, it is desirable that certain aspects be shared with anyone authorized by the owner. For example, a bridal registry should be available on-line. Furnishings for a new addition to a house can be made available for comment and/or ranking by anyone authorized by the owner, who may have excellent ideas for alternative furnishings.

When a global shopping cart is established, there is a need for managing data relationships between the global shopping cart and various data management access components. There is a need of the owner or user of the global shopping cart to selectively obtain data in the quickest amount of time.

### SUMMARY OF THE DISCLOSURE

There is provided a system and/or a method for managing data relationships between a global shopping cart and various manager components that encompass data management access.

There is also provided a system and/or a method for data management in a global shopping cart that allows the owner or user of the global shopping cart to selectively obtain data in the quickest amount of time.

There is provided a system and/or a method for managing data relationships between a global shopping cart and manager components that interface with various data stores in the global shopping cart.

There is further provided a system and/or a method for managing data relationships between a global shopping cart and various manager components including a merchant and partner data manager, a cloud data manager and a global shopping cart data manager.

The present disclosure provides a computer readable non-transitory storage medium storing instructions of a computer program that when executed by a computer system results in performance of steps for creating and operating a data management interface.

### BRIEF DESCRIPTION OF THE DRAWINGS

FIG. 1 is block diagram of system for implementing an exemplary embodiment of a global shopping cart that can use the data management system of the present disclosure.

FIG. 2 is a diagram illustrating the components (including various data stores) of an exemplary shopping cart in accordance the present disclosure.

FIG. 3 is a diagram illustrating managers of an exemplary data management system (API) that can be used with the global shopping cart of FIG. 2.

FIG. 4 is a diagram illustrating the data access components of an exemplary merchant and partner data manager that can be used with the global shopping cart of FIG. 2.

FIG. 5 is a diagram illustrating the data access components of an exemplary cloud data manager that can be used with the global shopping cart of FIG. 2.

FIG. 6 is a diagram illustrating the data access components of an exemplary shopping cart data manager that can be used with the global shopping cart of FIG. 2.

FIG. 7 is a diagram illustrating the interrelationships between data sources of data managers of an exemplary data management system (API) that can be used with the global shopping cart of FIG. 2.

FIG. 8 is a flow chart representing the manner in which a user or owner uses the shopping cart including the retrieval of desired data from data stores in the global shopping cart.

A component or a feature that is common to more than one figure is indicated with the same reference number in each figure.

### DESCRIPTION OF THE PREFERRED EMBODIMENT

The following terms are used herein.

An entity is the owner of a global shopping cart. Entities may include, but are not limited to, a person, business, consortium of businesses (such as, by way of example, the businesses in a local shopping mall or businesses selling the same lines of products in different locations), school, club, fraternity or sorority, an organization having members in a particular trade or profession, sales representative for a particular product, charity, not-for-profit organization, labor union, local government, government agency, and political party.

A task is something that is done on a one time or repetitive basis. A task may be a continuous endeavor, such as, for example, controlling inventory or office supplies. A task may be a project, such as, for example, planning a wedding, which can take a long period of time, approximately a year or longer, but is nonetheless contemplated to be a single event. A task can include a project, such as, for example, remodeling or redecorating a home or office, that can take several years.

An operator is an individual or an organization that operates a server that hosts one or more global shopping carts. An operator can be a payment network operator, such as MasterCard Incorporated, another business, or a consortium of businesses. However, it will be understood that there are other possible operators and types of global shopping carts, such as, for example, a mobile telephone company. There can be a mobile, global shopping cart that is analogous to a so-called m-commerce (mobile commerce) site. The mobile shopping cart is designed to operate with the resources available on a mobile device, such as, for example, a smart phone.

A user of a global shopping cart can be the entity or owner, or anyone authorized by the owner, including a merchant, to use the global shopping cart. For example, if the owner is an individual, that owner may authorize his or her family members (generally a spouse or older child) or a particular merchant, or merchant representative like a personal shopper, to use the global shopping cart. If the owner is a business, certain employees or other businesses in cooperation with the owner's business can be authorized to use the global shopping cart 300.

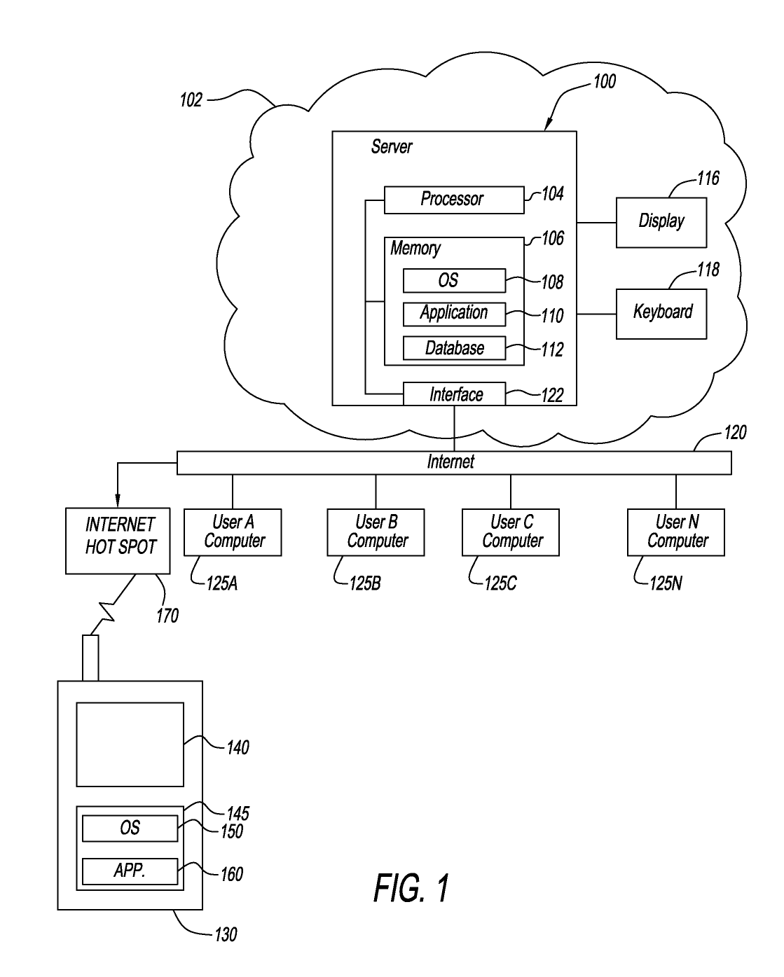

Referring to the drawings and, in particular, FIG. 1, a web site is operated on a server generally referred to as 100. The server 100 is in the cloud 102. Server 100 is connected to the Internet 120 by an interface 122. Server 100 includes a data processor 104 and a memory 106. Server 100 is connected to a display 116 and a keyboard 118. It will be understood that server 100 may have a number of other peripheral devices either customarily found in any computer, such as, for example, a CD or DVD drive (not shown), for placing programs on server 100 or for creating physical records of data processed by server 100. The peripheral devices are associated with or connected to server 100.

Memory 106 has a memory portion 108 for an operating system (“OS”) for server 100, a memory portion 110 for one or more application programs, including one that is the subject of this disclosure, and a memory portion 112 used as the storage for a database, as more fully described below.

The data of the database stored in memory portion 112 may be stored in any type of memory, including a hard drive, a flash memory, a CD, a RAM, or any other suitable memory, with provisions for suitable backup as known in the art.

User or access computers 125A, 125B, 125C to 125N can access server 100 via a connection to the Internet 120, as described below.

The entity that operates server 100 may be a payment network operator such as MasterCard Incorporated. The operator may provide rules as to who can establish a global shopping cart. For example, a holder of a credit card issued by an issuing bank of the operator may establish a global shopping cart at no cost. There may be a modest fee for others who authenticate their identity, on a one time, monthly or yearly basis. If there is a minimum amount of purchasing activity initiated via the global shopping cart, the fee can be waived.

A mobile communication device 130, such as, for example, and not by way of limitation, a telephone, has a display 140 and may have a memory 145 for storing an operating system 150 and series of applications or applets therein. The series of applications or applets include an applet or application program (hereinafter an application) 160. Mobile communication device 130 can access server 100 via an Internet connected Wi-Fi hot spot 170 (or by any telephone network, such as a 3G or 4G system, on which mobile communication device 130 communicates) by using application 160. Application 160 may include MasterPass™ capability so that Internet purchases are quickly and easily completed. It is preferable that application 160 be a relatively thin application. Further, application 160 is preferably not particularly complex, so that operation on a mobile device, including those devices without great computing resources, is facilitated.

A cart or global shopping cart 300 in accordance with the disclosed embodiment may be accessed by a user using a computer 125A, 125B, 125C to 125N, or by using mobile communication device 130. Purchases can also be made by a consumer using an access computer 125A, 125B, 125C to 125N, or by using mobile communication device 130. However, it will be understood that the web site being operated on server 100 may be accessed from a home or business computer, a personal digital assistant, a game console, a home appliance such as, for example, a smart refrigerator, any other Internet connected communication device, such as, a tablet or other mobile device (for example, an iPad® or an Ultrabook), or any stationary device, such as, for example, a kiosk.

The global shopping cart 300, once established, remains in effect for the life of the person who established it, and in some instances beyond, and also allows purchases to be made internationally. The global shopping cart 300, or the information contained therein, can, for example, become an asset of an estate. This may be especially applicable as between partners or spouses who often share at least some other joint assets. The global shopping cart 300 allows purchases to be made internationally. Aspects of global shopping cart 300 can be shared with others, such as family, friend, and colleague, to allow for their participation in special projects or long term projects. Thus, an invitee has the possibility of access to and serving, not only the creator of the global shopping cart 300, but also family, friends, invitees and anyone else, including other invitees, who is given access to the global shopping cart 300. An invitee may be, for example, a personal shopper for the individual who owns the global shopping cart 300. Other entities may be granted access to global shopping cart 300 to perform selected functions, as the owner of the global shopping cart 300 determines. The granted access will be managed by the owner of global shopping cart 300 by controlling the profile of the entity and with due regard for the privacy of the owner's data.

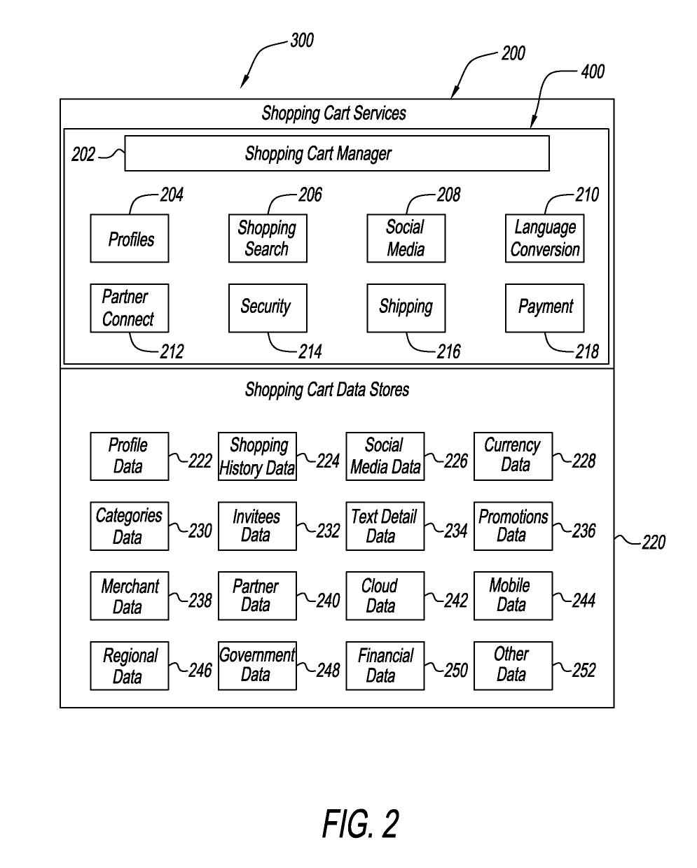

Referring to FIG. 2, components of a global shopping cart 300 are illustrated. An application on server 100 provides computer readable instructions for causing processor 104, as shown in FIG. 1, to provide shopping cart services 200. After opening a browser, a log-on screen is displayed on the user's computer 125A. The user may be required to log on by using a user name and password. Alternatively, application 160 on mobile communication device 130 may provide automatic log on capability when application 160 is activated.

Referring to FIG. 2, shopping cart services 200 include a shopping cart manager 202 that manages the shopping cart services, such as, for example, profiles 204 of shopping behavior, a shopping search function 206, social media 208, language conversion 210, partner connect 212, security 214, shipping 216, and payment 218. Profiles 204 of shopping behavior include, for example, attributes, such as, where shopping is done, whether it is on-line or in person, and amounts spent in various categories. Profiles 204 also includes a user profile with the characteristics of the user, such as, for example, age range, income range, gender, and town of residence. Thus, a merchant's access to this information is valuable in establishing the merchant' products, services and inventory.

Shopping search function 206 includes electronic storage for items that have been selected for purchase, and information concerning the vendor, the price, a photograph, a video clip, lead time until shipment, and other similar information. The shopping search function 206 can make one or more purchases on-line via one or more appropriate web sites, and can store the information needed to otherwise make the purchase, such as telephone information, or the exact location of a local store or product outlet.

Social media interface 208 supplies selected and non-confidential information to a selected social media web site that the user of global shopping cart 300 has joined, such as for example, Facebook®. Alternatively, an interface 208 to a social media web site developed specifically for global shopping cart 300 can be used. In either case, the social media interface 208 will allow others, most preferably friends and family, but possibly a merchant, or merchant representative like a personal shopper, to participate in a project by offering suggestions, suggesting alternatives, and possibly even buying items, such as gifts, for the owner of global shopping cart 300.

Access to global shopping cart 300 can include screening of data. A private area or page may be established, for example, for viewing by an invitee desired by the owner. The invitee can log on with, for example, a user name, password, and the telephone number of their personal mobile telephone. Security may be enhanced by using any security protocol that is currently used, such as, for example, a personal phrase, a security question, an image, an e-mail address, a real time SMS PIN received from the global shopping cart 300, that must be entered to gain access, or any other security device or protocol.

Language conversion module 210 assists in international shopping activities. The word content of web pages can be converted to the language of choice of the global shopping cart owner.

Partner connect function 212 is also provided. A partner is anyone other than the owner of global shopping cart 300, and thus could be a merchant or a merchant's designee, such as, for example, a personal shopper. Typically, a partner is a merchant or contractor who provides goods or services in connection with a category directed to a particular theme or project. Limited access is granted to that information required to complete a theme or project, or if the contractor is managing that theme or project, all relevant information. A contractor may send a message similar to a friend request. In response to that message, in some cases, or at the beginning of a relationship, read-only rights to the global shopping cart 300 may be provided. Later, the contractor may be given the right to provide comments. If the contractor is hired, full rights including the right to make purchases to complete a project, can be provided. This may be done by providing a screen, or portion of a screen, where appropriate boxes may be checked to provide different rights, or check marks removed to withdraw those rights. If there is any change in the task or category, an alert may be provided to the user of global shopping cart 300.

Security module 214 provides varying levels of security for global shopping cart 300. Security module 214 can include both secure and non-secure areas for various themes. A completely secure area is only accessible by the owner of shopping cart 300. Other areas or non-secure areas can be defined for joint access. Still other areas may be defined for shared or communal access. Each area can have a different level of security to which invitees may be granted access. For example, a secure area may include a wedding or home remodeling theme. An unsecured area may be one that is open for donations, such as, for example, for a local school event or a favorite charity.

An invitee to a portion of global shopping cart 300 must register to gain access to the cart. Also, a registration is preferably required to assist in controlling unauthorized access by spammers and/or those seeking to commit fraud. Once registered, an invitee can review items in the area or areas of the carts to which the invitee has been granted access. Thus, this is beneficial to a merchant for many reasons besides the particular task. In accordance with the privileges granted, the invitee may be able to view one or more items, add items, change items, remove items, and add or view links or pictures, and such other analogous additions, deletions or changes. The access of an invitee may be terminated or limited by the owner of global shopping cart 300 at any time.

In general, the cart owner will control all aspects of security over the entire life of the owner or for the entire life of the global shopping cart 300. Major life changes for an individual, such as marriage, divorce, cohabitation, moving to another country, or death of a spouse or significant other, could potentially have a great impact on the configuration of the cart and the access rights to various areas. Analogous concerns may apply to an owner that is a business or other organization.

One or more global shopping carts 300 can be established by the various entities defined above. For example, a non-profit entity may wish to establish a shared or communal cart that any person can access to add a generic donation item and then enable payment for that item to be made. An entity could also post a wish list of items needed to accomplish its goals with the hope that others will provide the item, based on items already on hand, or based on a link to the item that is added to the cart so that it can be purchased for charity. An alert function can be provided so that a global shopping cart owner can opt-in to receive alerts for charities they have identified.

An entire cart or parts of a cart may be moved or copied from one global shopping cart 300 to another global shopping cart. This may be appropriate where global shopping carts 300 are established by entities, such as two or more businesses and a merger there between occurs. Where a home is being remodeled, access to that portion of the cart can be granted to the owner of another cart to use as a template. One advantage to the recipient carts is that access could be granted to the invitee list for that portion of the cart, which may include professional contacts, such as remodeling companies, city or county permit contacts, or other contacts pertinent to accomplishing the task for which that portion of the cart was created.

A shared space or communal area of global shopping cart 300 can be configured to be open to anyone. A cart owner may create an area for purchase of a used automobile and within that area provide some criteria for the item to be purchased, such as make, model, accessories, mileage requirements, pictures illustrating the desired color, and any special features. A price range for the item that states how much the cart owner is willing to pay can also be specified. Anyone accessing the shared space can search the network of carts having a shared or communal area for the listed item, and offer a response or provide a link, pictures or contact details to propose an item for purchase by the cart owner. The cart owner may accept or decline such proposals. As used herein, purchase means some reciprocation in value whether it be an equal value or agreed upon value. Thus, purchase can be in the form that includes, but is not limited to, money, barter, gift certificate and point program.

Shipping module 216 manages and keeps track of items that have been ordered and their location in the shipping network, as advised by the various carriers. Item tracking numbers are followed. Alerts provided by the shippers can be forwarded to the owner of the cart by various “push technologies”, including, but not limited to, e-mail, voicemail, and instant messenger. Alternatively, the owner of the cart, or a person who has been granted access to the cart, can access the cart and bring up a page or an API on the accessing device, and check current status. The shipping module may also be used to compute or keep track of shipping costs, which for purchases from distant vendors, may make a difference as to whether a particular purchase is made, or whether it is made from that vendor.

Payment module 218 provides for payment for any items purchased in the global shopping cart 300. Payment module 218 may have the characteristics of one or more payment modes or sources, e.g., digital wallet, and may allow access to a plurality of accounts or funding sources. When purchases are made, acknowledgements of or receipts for the purchases may be managed by payment module 218. In the case of international purchases, currency computations, as described below, and shipping costs, as described above, may also be managed.

Data required for the operation of global shopping cart 300 is stored in shopping cart stores 220 shown in FIG. 2. The data in the cart stores 220 are stored in a format that makes it available for or translatable to other database technologies that may be developed in the future. This is of particular importance since the amount of data that must be retained and managed will be very large over the lifetime of global shopping cart 300. There are various forms and formats for storing the data in shopping cart stores 220. A preferred format can be an open source format. However, the various storage modules for the different kinds of data that are stored, are described below.

Referring again to FIG. 2, profile or profile store 222 stores the data for the profile or profiles created at 204. As noted above, a user profile with the characteristics of the user, such as, for example, age range, income range, gender, and town of residence, can be stored. If global shopping cart 300 is shared, the profiles of more than one person can be stored, such as that of family members authorized to use global shopping cart 300. A dollar limit on the spending of a minor child may also be stored as part of a profile. Shopping behavior, such as where shopping is done, whether it is on-line or in person, and amounts spent in various categories, can also be components of a user profile.

Shopping history data store 224 includes data or information on the items that have actually been purchased. Such data includes, but is not limited to, SKU number, price paid, where purchased, when purchased, method of purchase, source of funds, and type of purchase. This data may be used to as part of the formulation of profile 204 stored in profile data store 222.

Social information data store 226 includes data and information used by social media interface 208. Social media interface 208 interfaces with social media platforms, and information derived from social media web sites. This data and information may be used to access existing social media, or a social media site specifically intended to and designed for interaction with global shopping cart 300.

Currency data store 228 contains a database of currency exchange rates, as well as currency exchange fees charged by the various sources of funds used by payment module 218. These rates and fees can be updated on any periodic (for example, daily at 5:00 PM local time) basis by accessing various pertinent web sites and by downloading the information contained therein. A real time data service may be used to calculate or recalculate the exchange rates at the time a purchase is made. These rates and fees, as well as shipping costs, are of material assistance to anyone using global shopping cart 300 in evaluating the actual cost of an item, and in making a decision whether the item should be purchased from a particular source or, perhaps, whether it should be purchased.

Categories data store 230 is used to store data for items purchased by kind or type. This data storage can be based in part on SKU numbers, or can be stored in categories as created by the owner of the cart. In one embodiment, the creation of categories by the owner can be based on the themes established, such as remodeling of a home or a wedding. The storage by categories or themes enables the owner to track the allocation of funds for various purposes.

Invitees data store 232 stores the security data mentioned that is obtained when invitees register for access to a portion of global shopping cart 300. In particular, the information required to establish the various levels of security is stored.

Text detail data store 234 is used to store textual data and information. Textual data and information includes, but is not limited to, notes, one or more pictures, photographs, and links to web sites, audio and video files relating to items selected for inclusion in global shopping cart 300, and items suggested for inclusion by invitees. If the space required for the linked items is included, text detail store 234 can be quite large in terms of the storage resources required for all information.

Security measures may be put in place to assure that material that is uploaded to global shopping cart 300 is not done for illegal, immoral or other prohibited purposes. For example, filters can be used to block material that is pornographic, directed to illegal substances, or to other selected illegal activity, such as, for example, money laundering, terrorism, smuggling and making purchases with stolen credit card numbers. This may be accomplished in a variety of ways, including prohibiting transfer of data from certain web sites, or from web sites in countries where fraud is more likely, scanning content before it is posted, and checking for unusual activity, in a manner similar to that used for fraud alerts on credit cards. Analytics triggers can be used that would indicate suspicious shopping cart activity. Such an analytic trigger may be based on, for example, the number of people who have wide access to one or more sections of an individual person's cart. For example, if the purpose of a task is to plan a wedding, then twenty or perhaps no more than thirty people should be involved. If there are too many invitees, it is almost a certainty that proper security has not been maintained. Other indications that something improper may be happening include, but are not limited to, spending that does not fit the nature of the task or that is outside the usual spending patterns of the owner of the global shopping cart. Other examples of suspicious activity include transactions by the same individual originating in multiple geographic regions, and multiple sequential transactions with one merchant. Other problematic situations, while not illegal, include the posting of spam. This situation may prove distracting to invitees or cause them to be fearful of possible fraud, and discourage use of the global shopping cart. Anti-spam software, available from major software providers, can be used in conjunction with the global shopping cart to block access by known sources of spam. If there is inappropriate activity, or an obvious security breach, shopping cart activity can be suspended until the issue has been resolved.

Promotions data store 236 stores data and information relating to various sales promotions or discounts provided by vendors of goods in global shopping cart 300. The existence and nature of these items may be periodically updated by accessing the web sites of vendors of items in global shopping cart 300 (whether or not a purchase has been made) by interfacing to the shopping cart owner's e-mail to look for promotions or discounts, or by manually entering data at an appropriate screen based on information received elsewhere, such as by mail. Advantageously, the dates of expiration of these promotions or discounts can also be stored so that an alert can be sent to the owner of global shopping cart 300, any desired time prior to expiration, such as a day or week prior to expiration. This alert gives the owner an opportunity to decide whether to make the purchase at a time that takes advantage of the promotion or discount, or to wait anticipating a better promotion or discount may later be available.

Merchants data store 238 stores data and information relating to goods and services from various merchants, including merchants outside the country in which the global shopping cart is established. The store can include rewards offered by a particular merchant, such as those rewards generated by repeat business or purchases greater than some predetermined value. Coupon and promotional codes can also be stored. The data associated with a particular promotion, including the effective date and expiration date, can automatically be uploaded to global shopping cart 300.

Partners data store 240 stores data and information relating to partners and projects that they may be involved with, currently or in the past. A partner is anyone other than the owner of global shopping cart 300, and thus could be a merchant. Typically, a partner is a merchant or contractor who provides goods or services in connection with a category directed to a particular theme or project. Data and information are stored relating to a theme or project. This data may be used by partner connect 212.

Cloud data store 242 stores data and information from public and private clouds. For example, cloud data store 242 can include stored mobile data (many mobile devices do not allow storage of sensitive or are designed to handle huge data downloads), regional data (international data stored locally in a country for example), partner data, profile data, social media, historical data, image and video (large blob types of data), and government data. The data in this environment may include data that is interconnected with other data stores.

Mobile data store 244 stores data and information from mobile devices. For mobile devices that do not allow storage of sensitive or are not designed to handle huge data downloads, such data and information can be included in cloud data store 242.

Regional data store 246 stores data and information for specific geographic locations. For example, regional data can include international data stored locally in a country. This data and information can be useful, for example, in conducting business in a particular country or travel in a particular country.

Government data store 248 stores data and information from government sources that may be useful, for example, in conducting business in a particular country or travel in a particular country. The government data can include international data as well as domestic data.

Financial data store 250 stores data and information relating to finance including international finance, domestic finance as well as personal finance. The international and domestic finance data can include world markets, stock markets, currency exchange (which can also include currency data store 228), and the like. The personal finance data can include personal investment portfolios, savings, checking, and the like. This data and information can be updated on any periodic basis using the crawling function as described herein.

Other data stores 252 may also be included. Other data storage options such as advanced cloud storage capabilities, closed networks and government networks may result in other data stores 252.

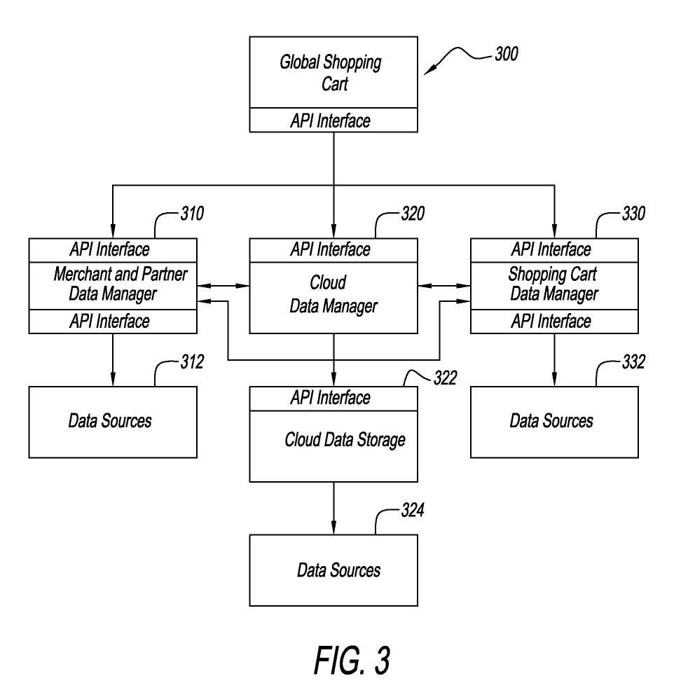

Referring to FIG. 3, the global shopping cart 300 offers a flexible API framework to manage the data relationships between the global shopping cart and the major components that encompass data management access. There are three primary components interfacing with various data stores including a merchant and partner data manager 310, a cloud data manager 320, and a shopping cart manager 330.

The merchant and partner data manager component 310 is connected, through an API interface, to data sources 312. Data sources 312, such as merchants and other partners, including, but not limited to, data warehouses, shipping facilities, port authorities, merchant web sites, and government sites. The purpose of this component 310 is to flexibly connect to the various merchants and partners and their data, and exchange information that the global shopping cart requires, including but not limit to, social media data, loyalty, rewards, inventory, shipping, SKU, profile, credentials, and relationship data.

The cloud data manager component 320 is connected, through an API interface, to public and private clouds 322 and has access to various data sources 324 as can be stored in these environments. The cloud data manager component 320 is flexible to expand over time. For example, the cloud data manager 320 can access stored mobile data (many mobile devices do not allow storage of sensitive or are designed to handle huge data downloads), regional data (international data stored locally in a country for example), partner data, profile data, social media, historical data, image and video (large blob types of data), and government data. The data in this environment can include data that can be interconnected with merchants/partners, and the global shopping cart data storage.

The shopping cart data manager component 330 is connected, through an API interface, to data sources 332 of all of the local or remotely stored shopping cart data. The data to be accessed includes, but not be limited to, profile data, security data, languages, financial, cart data, transaction data, connection data (includes links to other data storage), log data, currencies, history, loyalty, rewards, and payments data. The data accessed directly by the shopping cart data manager is considered some of the most local data dependent on quick access requirements, such as data to be displayed in a cart for purchase.

Each component described above will connect to the various data stores through a flexible API framework. The API framework has the ability to share links (references) between each component so that when one component needs information from another component, it is simple for the data to be retrieved. The shopping cart data manager can continually connect to various data sources to update relevant information for the cart owner. For example, a ‘crawler’ capability within the global shopping cart can determine when a coupon has expired and automatically try to refresh the coupon if a new one has been made available by the merchant. Other crawling functions can include, but are not limited to, updates to currency conversion rates for cross border transactions, updates on shipping data, and updates to remaining inventory.

In accordance with this disclosure, a flexible method is provided to owners of private and public clouds to connect easily to the global shopping cart and share data as it becomes available.

In accordance with this disclosure, the API is built with a flexible framework, anticipating other data storage options, such as advanced cloud storage capabilities, closed networks, and government networks. In accordance with this disclosure, as a control for the amount of data and information stored, the needs of the owner and users dictate the amount and type of information and data, availability, and updates. Data and information that is not needed by the owner or users should be removed from the data stores.

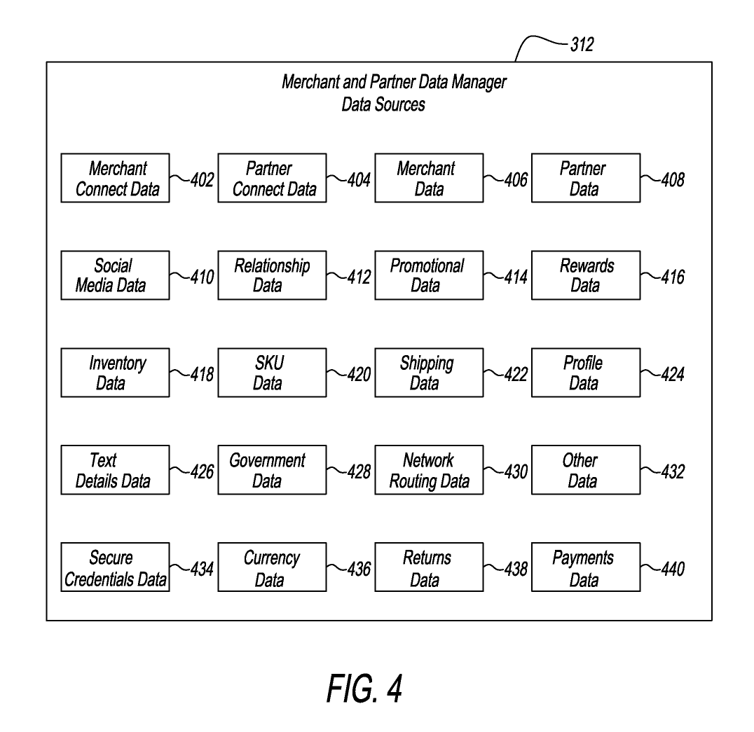

Referring to FIGS. 3 and 4, the data sources 312 of the merchant and partner data manager component 310 include, for example, merchant connect data 402, partner connect data 404, merchant data 406, partner data 408, social media data 410, relationship data 412, promotional data 414, rewards data 416, inventory data 418, SKU data 420, shipping data 422, profile data 424, text details data 426, government data 428, network routing data 430, secure credentials data 434, currency data 436, returns data 438, payments data 440, and other data 432.

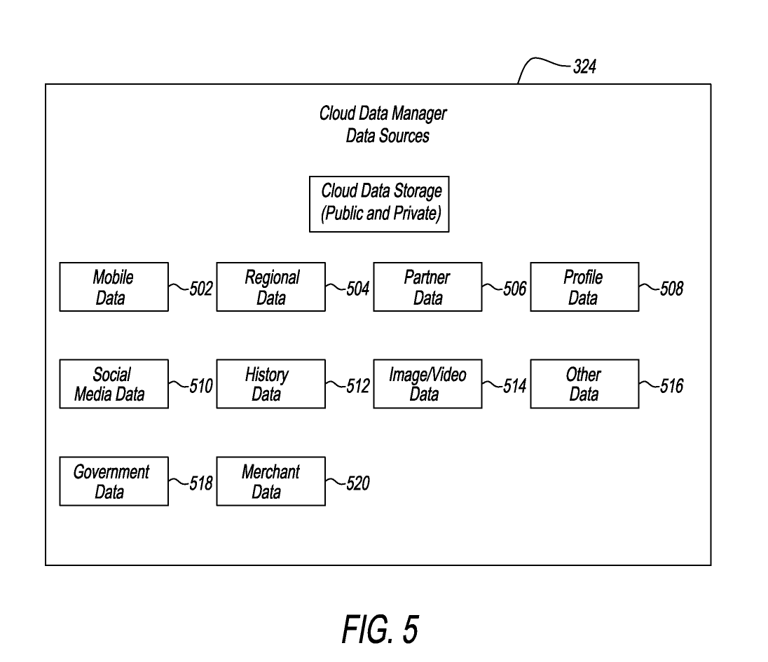

Referring to FIGS. 3 and 5, the data sources 324 of the cloud data manager component 320 include, but are not limited to, mobile data 502, regional data 504, partner data 506, profile data 508, social media data 510, history data 512, image/video data 514, government data 518, merchant data 520, and other data 516.

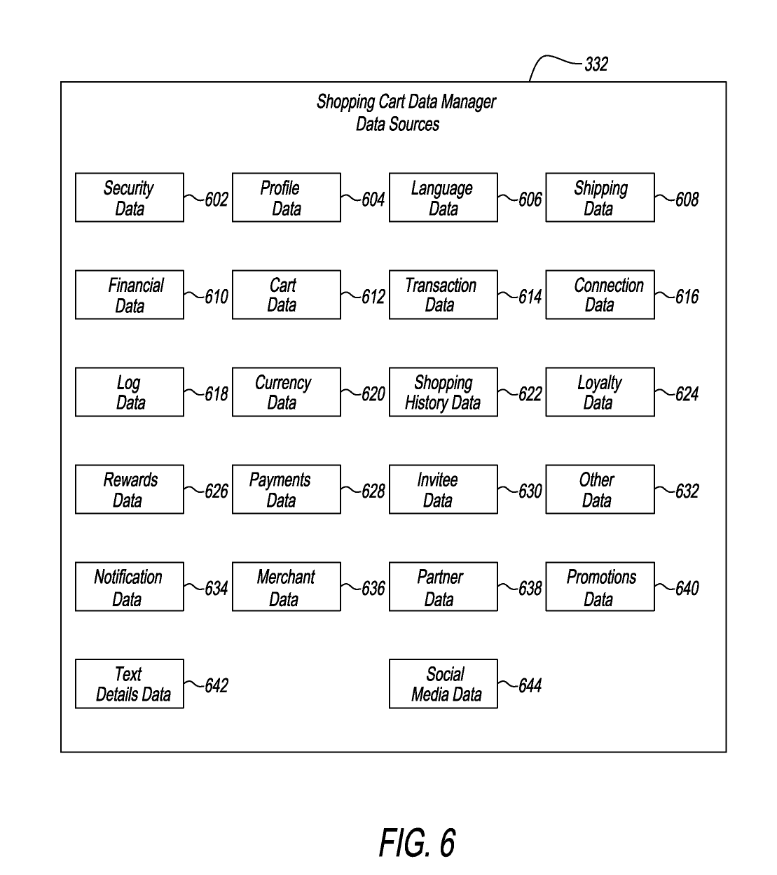

Referring to FIGS. 3 and 6, the data sources 332 of the shopping cart data manager component 330 include, but are not limited to, security data 602, profile data 604, language data 606, shipping data 608, financial data 610, cart data 612, transaction data 614, connection data 616, log data 618, currency data 620, shopping history data 622, loyalty data 624, rewards data 626, payments data 628, invitee data 630, notification data 634, merchant data 636, partner data 638, promotions data 640, test details data 642, social media data 644, and other data 632.

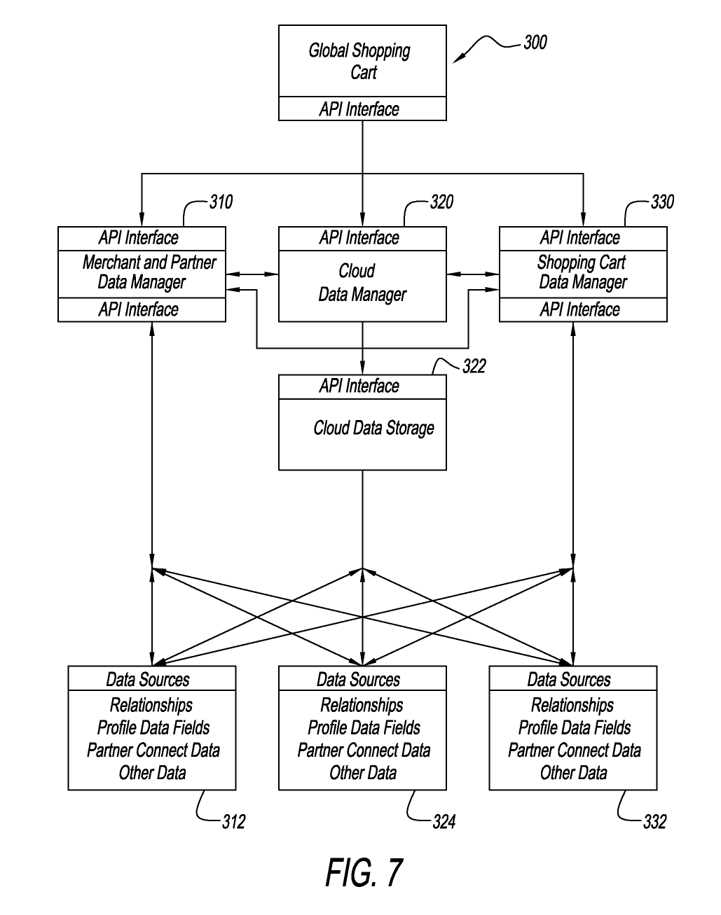

FIG. 7 illustrates the interrelationships between data sources of data managers for an exemplary data management system (API) that can be used with the global shopping cart of FIG. 2. FIG. 7 shows how the data sources 312, 324 and 332 of each of the merchant and partner data manager 310, the cloud data manager 320, and the shopping cart data manager 330 are interrelated with each other, and share data and links (references) amongst each other. Illustrative data of the data sources of the interrelationship include, but are not limited to, relationships, profile data fields, partner connect data, and other data. The interrelationships among the data sources allow the data to be made consistent across the various data managers of the global shopping cart, and readily accessible to the owner or users of the global shopping cart.

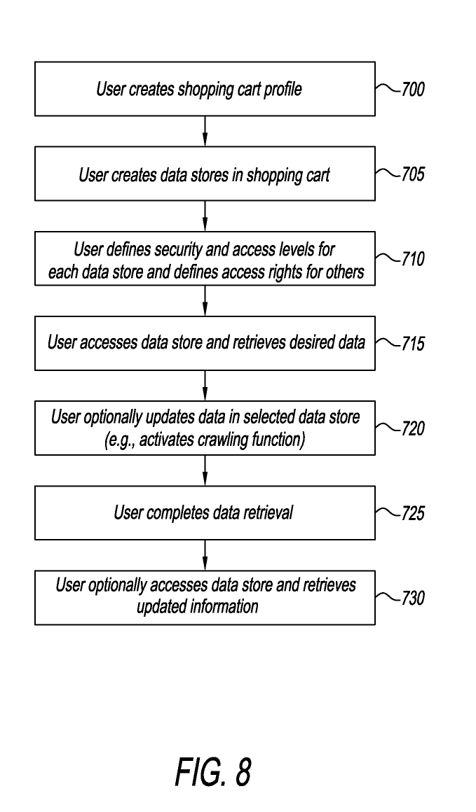

FIG. 8 illustrates the use of the data management system of the present disclosure in the creation and utilization of global shopping cart 300. At 700, the owner or someone authorized by the owner to use global shopping cart 300 (hereinafter collectively or separately referred to as a user) creates a profile for local shopping cart 300 by connecting to server 100 of FIG. 1. This operation may be accomplished by a mobile communication device or computer connection.

At 705, the user creates data stores in global shopping cart 300. As an alternative, a set of default data stores may be made available for selection by the owner of global shopping cart 300.

At 710, the user defines security and access levels for each data store and defines access rights for others. A message can be sent to others inviting them to participate in selected data stores via e-mail, or via social media interface 208 of FIG. 2.

At 715, the user and optionally invitees of global shopping cart 300 accesses the data stores and retrieves desired data therefrom. At 720, the user can optionally update data in selected data stores by using, for example, the crawling function described herein. At 725, the user completes the data retrieval. The user ends the session by logging out or closing the application being used.

At 730, after completion of the update of data and information at 720, the user can optionally access the data store again and retrieve updated information.

Global shopping cart 300 can be configured to provide access logs and various reports to the cart owner, such as, for example, a list of items purchased for a remodel, which may be of tax significance at a later time as adding to the tax basis of the house or may be of significance when an item must be repaired or replaced. In a small business, an office manager or a tax accountant may run reports. This may be of tax significance at a later time, such as, adding to the tax basis of the house, or may be of significance when an item must be repaired or replaced. Some items can be designated as tax deductible for the current tax year and, thus, for inclusion with annual tax filings. A report of invitee activity can be generated. The report can be reviewed as desired to determine which invitee made significant contributions, whether by way of suggestions that were adopted or by way of purchasing items for the cart owner as gifts. Reports summarizing daily, weekly, monthly and yearly spending may be generated. These reports can be sorted by merchant category, product category or SKU type, method of payment, currency used, country of purchase, date of purchase, amount spent per purchase, gift recipient, or in almost any other manner for which data has been supplied. The running of a report is an event that is logged with a record kept of the person who ordered or ran the report. Such reports are periodically given or immediately copied to the owner of the global shopping cart.

In view of global shopping cart 300 being accessible by an application on most, if not all, smart telephones, all images, videos, sounds or audios, and other data present on the smart phone can be uploaded in real time to the appropriate category or theme of global shopping cart 300 in real time. Some images, videos and sounds may be of special significance to the owner of global shopping cart 300 and will be available for a lifetime and, perhaps, beyond, to serve as reminders of particular significant events, such as vacations or social gatherings. Access can be granted to select family members and friends so that they can experience the sights and sounds of a joyous occasion or an adventure.

For an item purchased with global shopping cart 300, images, videos or sounds can be included with the item at the time of purchase or at a later time. For example, if a grandparent purchases a pet for a child, the grandchild can upload a special thank you video to be shared with the grandparent who has access to global shopping cart 300. Later generated items, such as a video of the child playing with the pet, can also be uploaded.

When global shopping cart 300 is accessed by a mobile device that has a GPS receiver, the location of the mobile device can become a basis for selecting the manner in which some of the functions described above operate. For example, a default currency, shipping methods and carriers, and browsing for items to be added for purchase, can be directed based on the current location of the mobile device.

One or more web sites may be established by shopping cart 300 for each task, category or theme established. Generic templates for a web page or a portion of a web page as well as customization tools can be provided. The global shopping cart 300 may have a standard or universal home page. A suite of tools (possibly accessible from a drop down menu), including a set of very simple and easy to use tools, as well as more complex tools that may require knowledge of how to write code in a language such as, for example, HTML, can be provided. The owner can use the tools most appropriate to his or her skill level to establish and maintain the page or pages on the web site. Options may include various widgets, which can be pulled from a menu and dropped at screen locations satisfactory to the user.

A dashboard display can be used to manage various functions and categories. A list of all categories can be displayed on the dashboard. A blog area or page may be established, with a forum section. A social area may be used to make friends and to invite them to join and access a task, category or theme. Alerts received from various sources can be linked to icons on the dashboard so that the user of global shopping cart 300 is made aware of the alert, by for example, flashing of the icon or a change in its color. An alert also can be provided by the use of audio, including playing a particular sound, tone or music, or the sounding of particular words. An alert can still also be provided in video form including the playing of a portion of a movie or other video clip.

An opt-in function for alerts can be provided by global shopping cart 300 for various categories or themes. For example, cat enthusiasts may be interested in receiving alerts relating to cats, such as cat food, cat grooming, and cat health products and services. A list of forums or relevant sites may be provided. Also, a box, checked or unchecked, for each site can be used to determine whether alerts are received when some new activity occurs on a site. This may apply to a product or a group of products. The owner or user of global shopping cart 300 will thus know when special promotions or advantageous sales terms are available.

It will be understood that the present disclosure may be embodied in a computer readable non-transitory storage medium storing instructions of a computer program that when executed by a computer system results in performance of steps of the method described herein. Such storage media may include any of those mentioned in the description above.

The terms “comprises” or “comprising” are to be interpreted as specifying the presence of the stated features, integers, steps or components, but not precluding the presence of one or more other features, integers, steps or components or groups thereof

It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

What is claimed is:

1. A global shopping cart comprising:
a storage medium having thereon computer instructions for implementing one or more functions of the global shopping cart; and
a processor for executing the computer instructions to provide functions including management of data relationships between the global shopping cart and manager components that encompass data management access;
wherein the global shopping cart has a flexible application programming interface framework sufficient to support the management of data relationships between the global shopping cart and the manager components.

2. The global shopping cart of claim 1, wherein the manager components have a flexible application programming interface framework sufficient to interface with the global shopping cart and data sources.

3. The global shopping cart of claim 2, wherein the manager components comprise a merchant and partner data manager, a cloud data manager, and a shopping cart data manager.

4. The global shopping cart of claim 3, wherein the merchant and partner data manager has a flexible application programming interface framework sufficient to interface with the global shopping cart and merchant and partner data sources.

5. The global shopping cart of claim 4, wherein the merchant and partner data sources comprise one or more data selected from the data group consisting of merchant connect data, partner connect data, merchant data, partner data, social media data, relationship data, promotional data, rewards data, inventory data, SKU data, shipping data, profile data, text details data, government data, network routing data, secure credentials data, currency data, returns data, and payments data.

6. The global shopping cart of claim 3, wherein the cloud data manager has a flexible application programming interface framework sufficient to interface with the global shopping cart and cloud data sources.

7. The global shopping cart of claim 6, wherein the cloud data sources comprise one or more data selected from the data group consisting of mobile data, regional data, partner data, profile data, social media data, history data, image/video data, government data and merchant data.

8. The global shopping cart of claim 3, wherein the shopping cart data manager has a flexible application programming interface framework sufficient to interface with the global shopping cart and shopping cart data sources.

9. The global shopping cart of claim 8, wherein the shopping cart data sources comprise one or more data selected from the data group consisting of security data, profile data, language data, shipping data, financial data, cart data, transaction data, connection data, log data, currency data, shopping history data, loyalty data, rewards data, payments data, invitee data, notification data, merchant data, partner data, promotions data, test details data, and social media data.

10. The global shopping cart of claim 8, wherein the shopping cart data manager has a crawling function capable of connecting to shopping cart data sources to update data for a cart owner or user.

11. The global shopping cart of claim 3, wherein the merchant and partner data manager, the cloud data manager, and the shopping cart data manager are interconnected with each other and share links (references) amongst each other.

12. A method for managing data in a global shopping cart, the method comprising:
storing computer instructions for implementing one or more functions of the global shopping cart on a storage medium; and
causing a processor to execute the computer instructions to provide functions including management of data relationships between the global shopping cart and manager components that encompass data management access;
wherein the global shopping cart has a flexible application programming interface framework sufficient to support the management of data relationships between the global shopping cart and the manager components.

13. The method of claim 12, wherein the manager components have a flexible application programming interface framework sufficient to interface with the global shopping cart and data sources.

14. The method of claim 13, wherein the manager components comprise a merchant and partner data manager, a cloud data manager, and a shopping cart data manager.

15. The method of claim 14, wherein the merchant and partner data manager has a flexible application programming interface framework sufficient to interface with the global shopping cart and merchant and partner data sources.

16. The method of claim 15, wherein the merchant and partner data sources comprise one or more data selected from the data group consisting of merchant connect data, partner connect data, merchant data, partner data, social media data, relationship data, promotional data, rewards data, inventory data, SKU data, shipping data, profile data, text details data, government data, network routing data, secure credentials data, currency data, returns data, and payments data.

17. The method of claim 14, wherein the cloud data manager has a flexible application programming interface framework sufficient to interface with the global shopping cart and cloud data sources.

18. The method of claim 17, wherein the cloud data sources comprise one or more data selected from the data groups consisting of mobile data, regional data, partner data, profile data, social media data, history data, image/video data, government data, and merchant data.

19. The method of claim 14, wherein the shopping cart data manager has a flexible application programming interface framework sufficient to interface with the global shopping cart and shopping cart data sources.

20. The method of claim 19, wherein the shopping cart data sources comprise one or more data selected from the data groups consisting of security data, profile data, language data, shipping data, financial data, cart data, transaction data, connection data, log data, currency data, shopping history data, loyalty data, rewards data, payments data, invitee data, notification data, merchant data, partner data, promotions data, test details data, and social media data.

21. The method of claim 19, wherein the shopping cart data manager has a crawling function capable of connecting to shopping cart data sources to update data for a cart owner or user.

22. The method of claim 14, wherein the merchant and partner data manager, the cloud data manager, and the shopping cart data manager are interconnected with each other and share links (references) amongst each other.
